(19) United States
(12) Patent Application Publication
(10) Pub. No.: US 2002/0081057 A1
(43) Pub. Date: Jun. 27, 2002

(54) Optical switch

(76) Inventor: Yueh-Liang Chung, Tu-Chen (TW)

Correspondence Address: Wei Te (Joseph) Chung, Foxconn International, Inc., 1650 Memorex Drive, Santa Clara, CA, 95050, US

(21) Appl. No.: 09/969,057

(22) Filed: Oct. 1, 2001

(30) Foreign Application Priority Data
Dec. 30, 2000 (TW) 89222905
Dec. 26, 2000 (TW) 89222495

(51) Int. Cl. G02B 6/35

(52) U.S. Cl. 385/16

(57) ABSTRACT

An optical switch (100) includes a first collimator (10), a second collimator (20), and an optical switching member (50), all encased in a shell (40). The first collimator retains an input fiber (1) and a first output fiber (2). The second collimator retains a second output fiber (3). The optical switching member includes a light-transmitting member (51), a piezoelectric actuator (30) and a reflector (52). When a controlling voltage is applied to the actuator, the actuator elongates and moves the reflector to block an optical signal from the input fiber to the second output fiber, and to reflect the signal to the first output fiber. When the controlling voltage is removed, the actuator moves the reflector out of the signal path, thus allowing the signal to go to the second output fiber.

### BACKGROUND OF THE INVENTION

1. Field of the Invention

The present invention relates to an optical switch, and particularly to an optical switch which achieves a switching operation by employing a piezoelectric device to control the movement of a reflective element in the optical switch.

2. Description of Related Art

Optical signals are commonly transmitted in optical fibers, which provide efficient light channels through which the optical signals can pass. Recently, optical fibers have been used in various fields, including telecommunications, where light passing through an optic fiber is used to convey either digital or analog information. Efficient switching of optical signals between individual fibers is necessary in most optical processing systems or networks to achieve the desired routing of the signals.

A typical optical switch has one or more light input port(s) and at least two light output ports for performing switching or logical operations to optical signals in a light transmitting line/system or in an integrated optical circuit. Factors for assessing the capability of an optical switch include low insertion loss (IL, <1 db), good isolation performance (>50 db), and fast switching speed (normally, tens of milliseconds).

Conventional mechanical optical switches come in two different designs: where the optical components move, and where the fibers move. Moving fiber switches involve the actual physical movement of one or more of the fibers to specific positions to accomplish the transmission of a beam of light from one fiber end to another under selected switching conditions. Moving optical component switches, on the other hand, include optical collimating lenses which expand the beam of light from the fibers, and then, using moving prisms or mirrors, reswitch the expanded beam as required by the switching process.

The moving fiber switches have a stringent tolerance requirement for the amount and direction of fiber movement. The tolerance is typically a small portion of the fiber core diameter for two fibers to precisely collimate to reduce loss. The fibers themselves are quite thin and may be subject to breakage if not properly protected. On the other hand, reinforcing the fibers with stiff protective sheaths makes the fibers less flexible, increasing the force required to manipulate each fiber into alignment. Thus these moving fiber optical switches share a common problem of requiring high precision parts to obtain precise positioning control and low insertion loss. This results in high costs and complicates manufacture of the switches. Moreover, frequently moving fibers to and fro is apt to damage or even break the fibers. The switching speed of these moving fiber optical switches is also slow.

Conventional moving optical component switches have less stringent movement control tolerance requirements because of the collimating lenses. However, problems with fatigue during operation make these switches not very reliable. Furthermore, these switches are usually much more complex. These inevitably require higher cost and more complicated manufacture.

### BRIEF SUMMARY OF THE INVENTION

An object of the present invention is to provide an optical switch which is easy to produce without requiring high precision components.

Another object of the present invention is to provide an optical switch having a high switching speed.

An optical switch in accordance with one embodiment of the present invention comprises first and second collimators, an optical switching member between the collimators, and a shell encasing the collimators and the switching member. The first collimator retains an input fiber and a first output fiber. The second collimator retains a second output fiber.

The optical switching member comprises a piezoelectric actuator and a reflector. The reflector is attached to the piezoelectric actuator. A controllable voltage is applied to the piezoelectric actuator, causing an elongation of the piezoelectric actuator corresponding to the amplitude of the voltage. When no controlling voltage is applied to the piezoelectric actuator, the optical signals from the input fiber travel toward the second output fiber. When the controlling voltage is applied to the piezoelectric actuator, the piezoelectric actuator elongates, causing the reflector to be displaced into a path of the optical signals between the input fiber and the second output fiber. The optical signals from the input fiber are incident onto the reflector and are reflected to the first output fiber.

Other objects, advantages and novel features of the invention will become more apparent from the following detailed description when taken in conjunction with the accompanying drawings.

### BRIEF DESCRIPTION OF THE DRAWINGS

FIG. 1 is a cross-sectional view of an optical switch according to the present invention before a controlling voltage is applied to a piezoelectric actuator.

FIG. 2 is a cross-sectional view of the optical switch of FIG. 1 after a controlling voltage is applied to the piezoelectric actuator.

FIG. 3 is a cross-sectional view of an alternate embodiment of the optical switch before a controlling voltage is applied to a piezoelectric actuator.

FIG. 4 is a cross-sectional view of the optical switch of FIG. 3 after a controlling voltage is applied to the piezoelectric actuator.

### DETAILED DESCRIPTION OF THE INVENTION

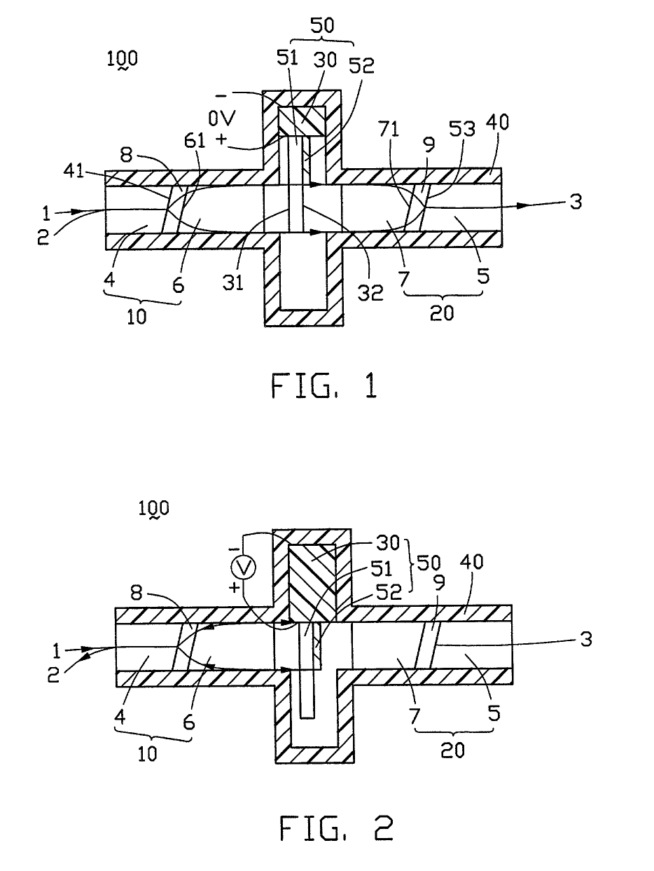

As shown in FIGS. 1 and 2, an optical switch 100 of the present invention comprises a first collimator 10, a second collimator 20, an optical switching member 50 and a shell 40. The shell 40 is preferably made of glass or metal and accommodates the collimators 10, 20 and the switching member 50 therein.

The first collimator 10 comprises a first port 4 and a first GRIN (graded index) lens 6. A first space 8 is present between the first port 4 and the first GRIN lens 6. Ends of an input fiber 1 and a first output fiber 2, which are preferably not fused together, are received and retained in the first port 4. The first port 4 has a slanted face 41 which is in close proximity to a reciprocally slanted face 61 of the quarter pitch first GRIN lens 6. The second collimator 20 comprises a second port 5 and a second GRIN lens 7. A second space 9 is present between the second port 5 and the second GRIN lens 7. A second output fiber 3 is received and retained in the second port 5. The second port 5 has a slanted face 53 which is in close proximity to a reciprocally slanted face 71 of the quarter pitch second GRIN lens 7. The end sections of the input fiber 1 and the first and second output fibers 2, 3 are dejacketed. The core and cladding of each fiber are exposed, and the exposed cladding and core may or may not be tapered. The first GRIN lens 6 and the second GRIN lens 7 are used to collimate a light beam propagating along substantially a longitudinal axis of the collimators 10, 20.

The optical switching member 50 comprises a piezoelectric actuator 30, a light-transmitting member 51, and a reflector 52. The light-transmitting member 51 can be, for instance, a transparent crystal. The piezoelectric actuator 30 is made of a piezoelectric material, such as aluminum nitride (AIN) or zinc If oxide (ZnO). The piezoelectric actuator 30 comprises two opposite sidewalls (not labeled) and two opposite ends (not labeled). One end of the piezoelectric actuator 30 is attached to the shell 40. The other end of the piezoelectric actuator 30 is attached to the reflector 52 and the light-transmitting member 51. Two sidewalls of the piezoelectric actuator 30 are in contact with the shell 40. When a controlling voltage is applied to the piezoelectric actuator 30, the piezoelectric actuator 30 elongates a predetermined length corresponding to the amplitude of the voltage applied, thereby moving the reflector 52.

The reflector 52 can be a thin, non-transparent plate made of metal, or it can be a second transparent crystal (not labeled) having a reflective film deposited on a rearward side of the second transparent crystal. The rearward side of the reflector 52 (and the rearward side of the second transparent crystal) faces away from a rearward facing second sidewall 32 of the light-transmitting member 51.

When the reflector 52 is comprised of the second transparent crystal, in order to achieve desired reflective performance, the reflective film normally comprises a reflective surface made of silver or another highly reflective material having a thickness of about 1 μm. Manufacture of such a reflector 52 can be accomplished using the following process:

1) providing a transparent, substantially planar crystal as the second transparent crystal;

2) forming the reflective surface by depositing a silver film or a film made of another highly reflective material on a rearward surface of the second transparent crystal to a thickness of about 1 μm;

3) forming a reflective material overlay by depositing one or more layers of the same or a second highly reflective material over the reflective surface to increase reflective performance; and

4) forming a protective film over the reflective material overlay. When assembling the completed second transparent crystal in the optical switch 100, the protective film (not labeled) faces away from the second sidewall 32 of the light-transmitting member 51.

The light-transmitting member 51 has a forward facing first sidewall 31 and the rearward facing second sidewall 32. The first and second sidewalls 31, 32 are parallel to each other and are perpendicular to the path of the light beams. The reflector 52 abuts the second sidewall 32. When the piezoelectric actuator 30 is actuated, the reflector 52 is moved by the piezoelectric actuator 30 in a direction parallel to the second sidewall 32 of the light-transmitting member 51. The light-transmitting member 51 helps maintain the reflector 52 in alignment perpendicular to the path of the light beams and prevents the reflector 52 from veering out of alignment.

FIG. 1 shows the optical switch 100 of the present invention before the controlling voltage is applied to the piezoelectric actuator 30. The reflector 52 is in a first, retracted position. Light beams from the input fiber 1 enter the first space 8. The first GRIN lens 6 collimates the light beams into parallel light beams. The parallel light beams strike the light-transmitting member 51. Since the material of the light-transmitting member 51 is transparent to the light beams, the light beams are transmitted through the light-transmitting member 51. The second GRIN lens 7 collimates the parallel light beams after they have passed through the light-transmitting member 51. The second output fiber 3 in the second port 5 receives the light beams collimated by the second GRIN lens 7.

FIG. 2 shows the optical switch 100 of the present invention after controlling voltage is applied to the piezoelectric actuator 30. The piezoelectric actuator 30 elongates a predetermined amount corresponding to the amplitude of the voltage applied, moving the light-transmitting member 51 and the reflector 52 in a direction to have the reflector 52 block the path of the light beams. The reflector 52 is thus in a second, extended position. The light beams from the input fiber 1 enter the first space 8. The first GRIN lens 6 collimates the light beams into parallel light beams. The parallel optical signals pass through the light-transmitting member 51 and hit the reflector 52, whereupon they are reflected back through the first GRIN lens 6. After being collimated by the first GRIN lens 6, they are received by the first output fiber 2. When the controlling voltage is removed from the piezoelectric actuator 30, the piezoelectric actuator 30 contracts, retracting the light-transmitting member 51 and the reflector 52 in an opposite direction, thereby moving the reflector 52 out of the path of the light beams. The light beams from the input fiber 1 transmitted through the first collimator 10 can then pass through the second collimator 20 and enter the second output fiber 3. By controlling the voltage applied to the piezoelectric actuator 30, the elongation of the piezoelectric actuator 30 is controlled and the direction of the transmission of the light beams from the input fiber 1 is controlled to be received either by the first output fiber 2 or by the second output fiber 3.

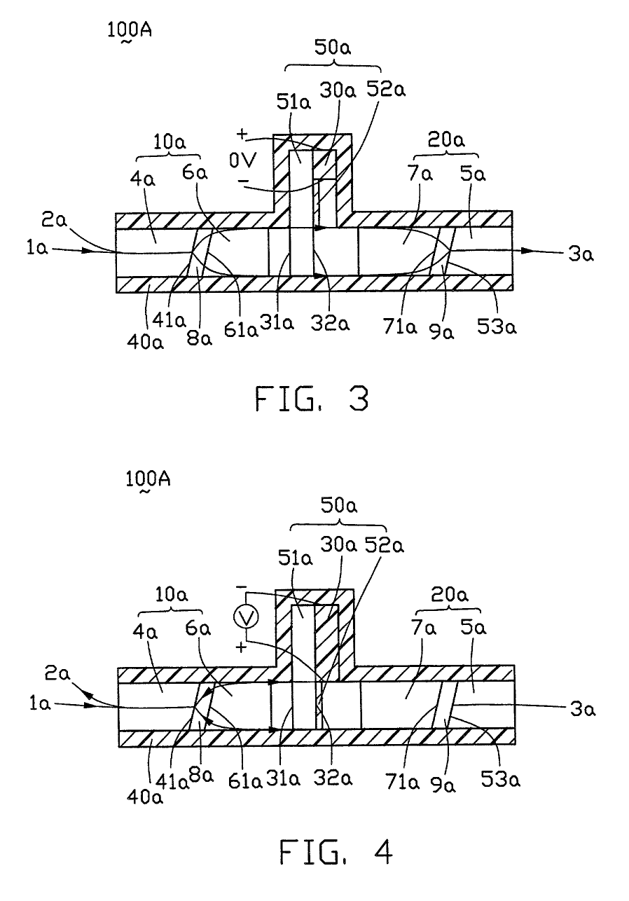

FIGS. 3 and 4 show an alternate embodiment of an optical switch 100A. This alternate embodiment optical switch 100A comprises a first collimator 10a, a second collimator 20a, an optical switch member 50a and a shell 40a. The first collimator 10a and the second collimator 20a are identical to the first collimator 10 and the second collimator 20 of the optical switch 100 described above and shown in FIGS. 1 and 2. Consequently, numerals used in FIGS. 3 and 4 are similar to those used in FIGS. 1 and 2 for corresponding parts. The optical switching member 50a comprises a piezoelectric actuator 30a, a light-transmitting member 51a, and a reflector 52a. One end of the piezoelectric actuator 30a is attached to the shell 40a. The other, opposite end of the piezoelectric actuator 30a is attached to the reflector 52a. One sidewall of the piezoelectric actuator 30a is in contact with the light-transmitting member 51a. The other sidewall is in contact with the shell 40a. A rearward side of the reflector 52a faces away from a rearward facing second sidewall 32a of the light-transmitting member 51a. The light-transmitting member 51a has a forward facing first sidewall 31a opposite the rearward facing second sidewall 32a. The first and second sidewalls 31a, 32a are parallel to each other and are perpendicular to the path of light beams entering the optical switch 100A. A portion of the first sidewall 31a abuts the shell 40a. The reflector 52a and the piezoelectric actuator 30a abut the second sidewall 32a. When a controlling voltage is applied to the piezoelectric actuator 30a, the piezoelectric actuator 30a elongates a predetermined length corresponding to the amplitude of the voltage applied, thereby moving the reflector 52a in a direction parallel to the second sidewall 32a of the light-transmitting member 51a. The light-transmitting member 51a helps maintain the reflector 52a in alignment perpendicular to the path of the light beams and prevents the reflector 52a from veering out of alignment.

FIG. 3 shows the optical switch 100A before the controlling voltage is applied to the piezoelectric actuator 30a. The reflector 52a is in a first, retracted position. Light beams from the input fiber 1a enter the first space 8a. The first GRIN lens 6a collimates the light beams into parallel light beams. The parallel light beams strike the light-transmitting member 51a. The light beams are transmitted through the light-transmitting member 51a. The second GRIN lens 7a collimates the parallel light beams after they have passed through the light-transmitting member 51a. The second output fiber 3a in the second port 5a receives the light beams collimated by the second GRIN lens 7a.

FIG. 4 shows the optical switch 100A after controlling voltage is applied to the piezoelectric actuator 30a. The piezoelectric actuator 30a elongates a predetermined amount corresponding to the amplitude of the voltage applied, moving the reflector 52a in a direction parallel to the second sidewall 32a of the light-transmitting member 51a. After controlling voltage is applied, the reflector 52a is thus in a second, extended position, as shown in FIG. 4, where the reflector 52a blocks the path of the light beams. The light beams from the input fiber 1a enter the first space 8a. The first GRIN lens 6a collimates the light beams into parallel light beams. The parallel light beams pass through the light-transmitting member 51a and hit the reflector 52a, whereupon they are reflected back through the light-transmitting member 51a and the first GRIN lens 6a. After being collimated by the first GRIN lens 6a, they are received by the first output fiber 2a. When the controlling voltage is removed from the piezoelectric actuator 30a, the piezoelectric actuator 30a contracts, retracting the reflector 52a in an opposite direction, thereby moving the reflector 52a out of the path of the light beams. The light beams from the input fiber 1a transmitted through the first collimator 10a can then pass through the second collimator 20a and enter the second output fiber 3a. By controlling the voltage applied to the piezoelectric actuator 30a, the elongation of the piezoelectric actuator 30a is controlled and the direction of the transmission of the light beams from the input fiber 1a is controlled to be received either by the first output fiber 2a or by the second output fiber 3a.

The operation of the optical switch embodiments 100, 100A is readily comprehended by examining, respectively, FIGS. 1 and 2 and FIGS. 3 and 4. The optical fibers, fiber ends, and collimators need not be moved to effect switching, as in many prior art switches. In fact, the only optical elements which move in the embodiments of the present invention are the reflector 52 and the light-transmitting member 51 (in the switch 100), and the reflector 52a (in the switch 100A). Since the light-transmitting member 51, the reflector 52, and the reflector 52a can be small, thin, two-sided, and of a conventional construction, the weight of the light-transmitting member 51, the reflector 52, and the reflector 52a can be kept low, reducing the load on the piezoelectric actuators 30, 30a.

The switching speeds of the optical switch embodiments 100, 100a are determined by the speed of movement of the piezoelectric actuators 30, 30a and are, in general, greater than 1 kHz/s. Therefore, the switching speeds of the optical switch embodiments 100, 100a are faster than those of conventional switches that require movement of fiber optic components.

The optical switch embodiments 100, 100A of the present invention are both simple and efficient. Both are economical to manufacture and both are capable of efficiently controlling the direction of transmission of optical signals. None of the parts utilized in the switches requires high precision machining and assembly can be accurately carried out without using expensive equipment or highly skilled personnel. Both switch embodiments are completely self-contained and the piezoelectric actuators 30, 30a are completely electrically operated.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An optical switch for switching light signals coming from an input fiber between a first output fiber and a second output fiber, comprising;
a first collimator retaining the input fiber and the first output fiber;
a second collimator retaining the second output fiber; and
a switching device comprising an actuator and a reflector, the reflector being moveable by the actuator from a first position where the reflector does not block transmission of a light signal from the input fiber to the second output fiber to a position where the reflector blocks said transmission and reflects the light signal to the first output fiber;
whereby, when a controlling voltage is not applied to the actuator, an optical signal from the input fiber transmits to the second output fiber and when a controlling voltage is applied to the actuator, the actuator elongates and moves the reflector into a path of the light signal between the input fiber and the second output fiber and the light signal is reflected by the reflector to the first output fiber.

2. The optical switch of claim 1, wherein the first collimator comprises a first port and a first GRIN lens.

3. The optical switch of claim 2, wherein the first port retains the input fiber and the first output fiber.

4. The optical switch as claimed in claim 2, wherein the first GRIN lens collimates light from the input fiber and light reflected by the reflector.

5. The optical switch of claim 1, wherein the second collimator comprises a second port and a second GRIN lens.

6. The optical switch of claim 5, wherein the second port retains the second output fiber.

7. The optical switch of claim 1, wherein the actuator is a piezoelectric actuator.

8. The optical switch of claim 1, wherein the reflector is attached to the actuator.

9. An optical switch for switching light signals coming from an input fiber between a first output fiber and a second output fiber, comprising;
a first collimator retaining the input fiber and the first output fiber;
a second collimator retaining the second output fiber;
a movable reflector; and
a driving member for moving the reflector between first and second positions, wherein, in the first position, light signals propagate from the input fiber to the second output fiber without being reflected by the reflector, and in the second position, light signals from the input fiber are reflected by the reflector to the first output fiber.

10. The optical switch of claim 9, further comprising a shell encasing the collimators, the reflector and the driving member.

11. The optical switch of claim 9, further comprising a light-transmitting member.

12. An optical switch for switching light signals coming from an input fiber between a first output fiber and a second output fiber, comprising;
a first collimator retaining the input fiber and the first output fiber;
a second collimator retaining the second output fiber;
a driving member; and
a reflector moveable by the driving member between a first position where the reflector does not block transmission of a light signal from the input fiber to the second output fiber and a second position where the reflector blocks the transmission and reflects the light signal to the first output fiber;
whereby, when a controlling voltage is not applied to the driving member, an optical signal from the input fiber transmits through the second output fiber, and when a controlling voltage is applied to the driving member, the driving member elongates and moves the reflector into a path of the light signal between the input fiber and the second output fiber and the light signal is reflected by the reflector to the first output fiber.

13. The optical switch of claim 12, wherein the reflector is a transparent crystal having a reflective film deposited on a rearward side of the transparent crystal, the reflective film including one reflective surface, and at least one reflective material overlay over the reflective surface, and a protective film over the reflective material overlay.

14. An optical switch for switching light signals between two output fibers, comprising:
a first collimator retaining a first input fiber and a first output fiber;
a second collimator retaining a second output fiber;
a reflector located between said first collimator and said second collimator and moveable between first and second positions; and
a driving member actuating said reflector to move between said first and second positions; wherein
when said reflector is in the first position to block a light path between the first collimator and the second collimator, the signals coming from the first input fiber will be reflected toward the first output fiber; when the reflector is in the second position not to block the light path, the signals coming from the first input fiber will be directed toward the second output fiber.

15. The switch of claim 14, wherein a light transmission device is constantly positioned between said first collimator and said second collimator regardless of whether the reflector blocks the light path of not.

16. The switch of claim 14, wherein said driving member is a piezoelectric actuator.

17. The switch of claim 14, wherein said reflector is moved in a direction perpendicular to said light path.

18. An optical switch for switching light signals, comprising:
a first collimator retaining an input fiber and a first output fiber therein and with a first GRIN lens thereof;
a second collimator opposite to said first collimator, retaining a second output fiber therein and with a second GRIN lens thereof, the second GRIN lens confronting the first GRIN lens; and
a reflector moveably positioned between said first GRIN lens and said second GRIN lens; wherein
when the reflector blocks a light path between the first GRIN lens and the second GRIN lens, light signals from the input fiber passing the first GRIN lens, are reflected by the reflector, and then backwardly passing the first GRIN lens again and to the first output fiber; when the reflector is removed from said light path, light signals from the input fiber passing the first GRIN lens, directly propagate through the second GRIN lens toward the second output fiber.

19. The switch of claim 18, wherein the reflector is actuated by a piezoelectric actuator.
